(19) United States
(12) Patent Application Publication
(10) Pub. No.: US 2022/0122406 A1
(43) Pub. Date: Apr. 21, 2022

(54) METHOD, SYSTEM, SERVER AND NON-TRANSITORY STORAGE MEDIUM FOR PROCESSING A BET ON A SPORTS GAME

(71) Applicant: ONELAB TECHNOLOGY LTD., Taipei City (TW)

(72) Inventors: Chan-Guan KOH, Taipei City (TW); Shih-Jung YU, Taipei City (TW); Hsin-Chih HSIEH, Taipei City (TW)

(21) Appl. No.: 17/205,950

(22) Filed: Mar. 18, 2021

Related U.S. Application Data
(60) Provisional application No. 63/093,549, filed on Oct. 19, 2020.

(51) Int. Cl. G07F 17/32; G06Q 50/34; G06F 3/0484

(52) U.S. Cl. CPC G07F 17/323; G06F 3/04845; G06Q 50/34; G07F 17/3288

(57) ABSTRACT

A method for processing a bet on a sports game includes: generating and displaying a first betting page for user interaction, the first betting page allowing selection of a time instance associated with a sports game; in response to receipt of user-input content indicating the selection of the time instance, generating and displaying a second betting page for user interaction, the second betting page allowing selection of an outcome associated with the time instance of the sports game; and in response to receipt of a bet that indicates the selection of the outcome associated with the time instance of the sports game, determining a result of the bet based on a result of the sports game at the time instance.

### CROSS-REFERENCE TO RELATED APPLICATION

This application claims priority of US Provisional Patent Application No. 63/093,549, filed on Oct. 19, 2020.

### FIELD

The disclosure relates to a method, a system, a server and a non-transitory storage medium for processing a bet on a sports game.

### BACKGROUND

Typically, sports betting on a sports game is to place a bet with respect to one or more aspects of the sports game, and a result of the bet is determined after a specific section of the sports game is finished. Taking betting on a soccer game as an example, a bet is typically placed on a halftime result of one half of the soccer game or on a final result of the entirety of the game. As for betting on a basketball game, a bet is typically placed on a result of one quarter, halftime of the game or the entirety of the game.

### SUMMARY

One object of the disclosure is to provide a method for processing a bet on a sports game. The method is designed to enable more variety of bets to be entered so as to create more incentives for people to enter bets.

According to one embodiment of the disclosure, the method is implemented using a server communicating with an end user device and includes the steps of:

generating a first betting page for user interaction and transmitting data of the first betting page to the end user device for the end user device to display the first betting page, the first betting page including a time selecting section that allows selection of a specific time instance associated with a sports game;

in response to receipt of user-input content indicating the selection of the specific time instance, generating a second betting page for user interaction and transmitting data of the second betting page to the end user device for the end user device to display the second betting page, the second betting page including a betting option section that allows selection of a specific outcome associated with the specific time instance of the sports game; and

in response to receipt of a bet that indicates the selection of the outcome associated with the specific time instance of the sports game, determining a result of the bet by comparing a result of the sports game at the specific time instance and content of the bet.

Another object of the disclosure is to provide a system that is configured to implement the above-mentioned method.

According to one embodiment of the disclosure, the system includes a server, and an end user device that is in communication with the server and that includes an input interface and a display.

The server is configured to generate a first betting page and to transmit data of the first betting page to the end user device so that the display is controlled to display the first betting page. The first betting page includes a time selecting section that allows selection of a specific time instance associated with a sports game.

In response to receipt of user-input content indicating the selection of the specific time instance, the end user device transmits the user-input content to the server, and the server is configured to generate a second betting page and to transmit data of the second betting page to the end user device so that the display is controlled to display the second betting page for user interaction. The second betting page includes a betting option section that allows selection of a specific outcome associated with the specific time instance of the sports game.

In response to receipt of a bet that indicates the selection of the outcome associated with the specific time instance of the sports game, the end user device transmits the bet to the server, and the server is configured to determine a result of the bet by comparing a result of the sports game at the specific time instance and content of the bet.

Another object of the disclosure is to provide a server that is configured to implement the above-mentioned method.

According to one embodiment of the disclosure, the the server includes a data storage storing current information regarding a sports game and instructions, a communication unit configured to communicate with an end user device, and a processor. The processor is configured to execute the instructions stored in the data storage to:

generate a first betting page, and transmit data of the first betting page to the end user device for the end user device to display the first betting page for user interaction, the first betting page including a time selecting section that allows selection of a specific time instance associated with the sports game;

in response to receipt of user-input content indicating the selection of the specific time instance from the end user device, generate a second betting page based on the current information of the sports game, and transmit data of the second betting page to the end user device for the end user device to display the second betting page for user interaction, the second betting page including a betting option section that allows selection of a specific outcome associated with the specific time instance of the sports game; and

in response to receipt of a bet that indicates the selection of the outcome associated with the specific time instance of the sports game from the end user device, determine a result of the bet by comparing a result of the sports game at the specific time instance and content of the bet.

Another object of the disclosure is to provide a non-transitory storage medium which stores computer readable instructions that, when executed by a processor of a computing device, cause the processor to perform the steps of the above-mentioned method.

### BRIEF DESCRIPTION OF THE DRAWINGS

Other features and advantages of the disclosure will become apparent in the following detailed description of the embodiments with reference to the accompanying drawings, of which:

FIG. 1 is a flow chart illustrating steps of a method for processing a bet on a sports game according to one embodiment of the disclosure;

FIG. 2 is a block diagram of an exemplary system for implementing the method of FIG. 1, according to one embodiment of the disclosure;

FIG. 3 illustrates an exemplary first betting page allowing a user to select a specific time instance of a sports game; and

FIGS. 4 to 9 illustrate examples of a second betting page allowing the user to select at least one of a plurality of betting options each associated with a specific outcome of the sports game.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” may refer to a direct connection among a plurality of electrical apparatus/devices/equipments via an electrically conductive material (e.g., an electrical wire), or an indirect connection between two electrical apparatus/devices/equipments via another one or more apparatus/device/equipment, or wireless communication.

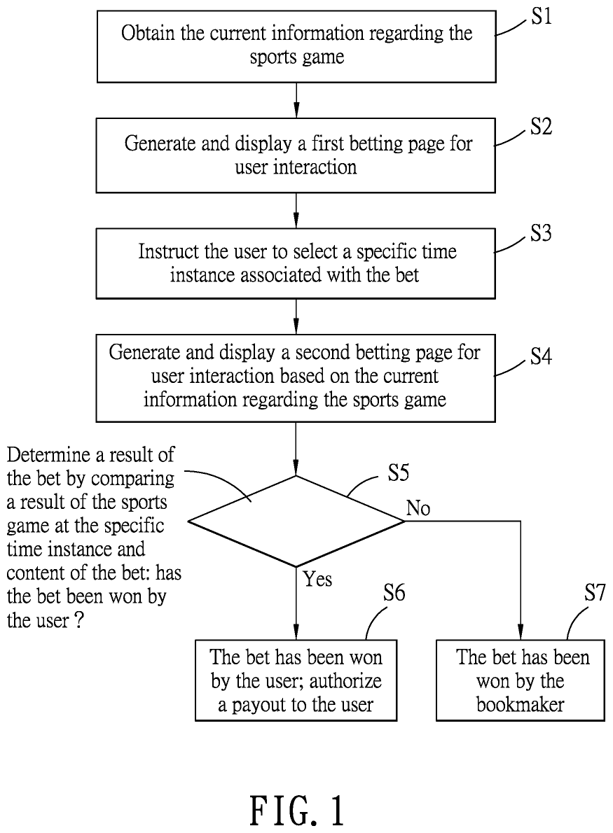

FIG. 1 is a flow chart illustrating steps of a method for processing a bet on a sports game according to one embodiment of the disclosure.

In this embodiment, the method may be implemented using an end user device, a server or a system that is programmed to perform the steps of the method.

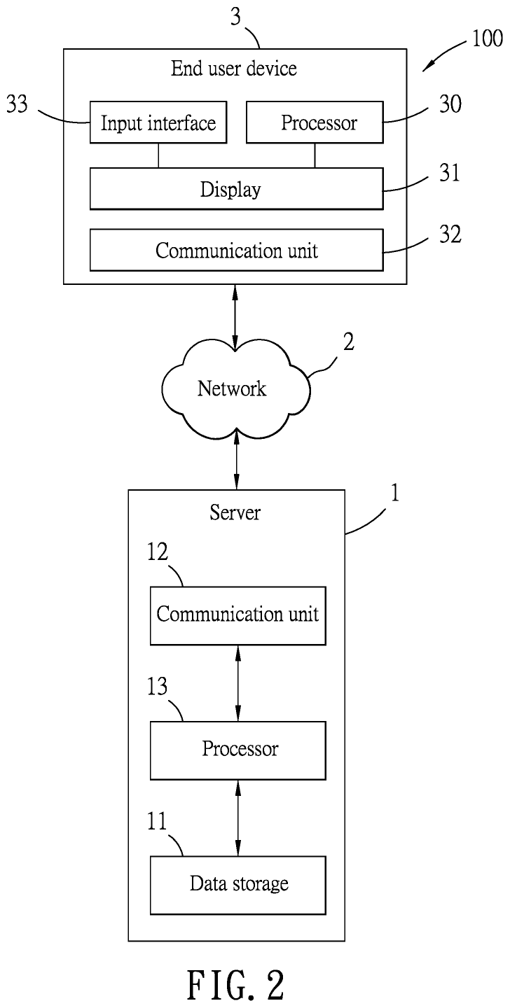

FIG. 2 is a block diagram of an exemplary system 100 for implementing the method of FIG. 1, according to one embodiment of the disclosure. In this embodiment, the system 100 includes a server 1 and an end user device 3. The server 1 and the end user device 3 may be configured to communicate over a network 2 (e.g., the Internet).

The server 1 includes a data storage 11, a communication unit 12 and a processor 13.

The processor 13 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The communication unit 12 is coupled to the processor 13, and may include at least one of a radio-frequency integrated circuit (RFIC), a short-range wireless communication module supporting a short-range wireless communication network using a wireless technology of Bluetooth® and/or Wi-Fi, etc., Or a mobile communication module supporting telecommunication using Long-Term Evolution (LTE), the third generation (3G) and/or fifth generation (5G) of wireless mobile telecommunications technology, and/or the like. In this embodiment, the communication unit 12 is configured to establish a connection with the network 2, so as to obtain current information regarding sports game(s) from another source through the network 2.

The term “sports game” may refer to a game of various kinds of sports (e.g., soccer, basketball, football, hockey, etc.). The current information regarding a sports game may be obtained from an official source (e.g., an official website managed by a league of the sports game), and may include a number of aspects such as a time structure, a number of parties participating in the sports game (typically two teams including a home team and an away team), a current progress of the sports game, a set of scores regarding the parties participating in the sports game, etc. For example, the time structure for a soccer game typically includes two 45-minute periods (called first half and second half, respectively), and the time structure for a basketball game typically includes four 10- or 12-minute periods (called first, second, third and fourth quarters, respectively) or two 20-minute periods (called first half and second half, respectively) depending on the organizations hosting the game (e.g., in the National Basketball Association, each of the games include four 12-minute periods).

The data storage 11 is coupled to the processor 13, and may be embodied using one or more of a hard disk, a solid-state drive (SSD) and other non-transitory storage medium. The data storage 11 stores the current information regarding a number of sports games, and a software application including instructions that, when executed by a processor (e.g., the processor 13 shown in FIG. 2), cause the processor to perform steps of the method shown in FIG. 1.

The end user device 3 may be embodied using a personal computer, a laptop, a tablet, a mobile phone, etc., and includes a processor 30, a display 31, a communication unit 32 and an input interface 33. In this embodiment, the end user device 3 is a terminal computer device that is in communication with the server 1.

The processor 30 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), etc.

The communication unit 32 is coupled to the processor 30, and may include at least one of a radio-frequency integrated circuit (RFIC), a short-range wireless communication module supporting a short-range wireless communication network using a wireless technology of Bluetooth® and/or Wi-Fi, etc., or a mobile communication module supporting telecommunication using Long-Term Evolution (LTE), the third generation (3G) and/or fifth generation (5G) of wireless mobile telecommunications technology, and/or the like. In this embodiment, the communication unit 32 is configured to establish a connection with the server 1 via the network 2, so as to obtain current information regarding several sports games.

The input interface 33 may include a mouse/keyboard. In some embodiments, the display 31 and the input interface 33 may be integrated as a touchscreen.

In use, when a user intends to join sports betting to place a bet on a sports game, he/she may operate the end user device 3 to establish a connection with the server 1.

In step S1, a user may operate the input interface 33 to execute an application program stored in the end user device 3 to communicate with the server 1 or to use a browser to access a website provided by the server 1 for obtaining the current information regarding the sports game.

In response, in step S2, the processor 13 of the server 1 generates a first betting page for user interaction, and controls the electronic device 3 to display the first betting page. The first betting page includes a time selecting section that enables selection of a specific time instance associated with a sports game.

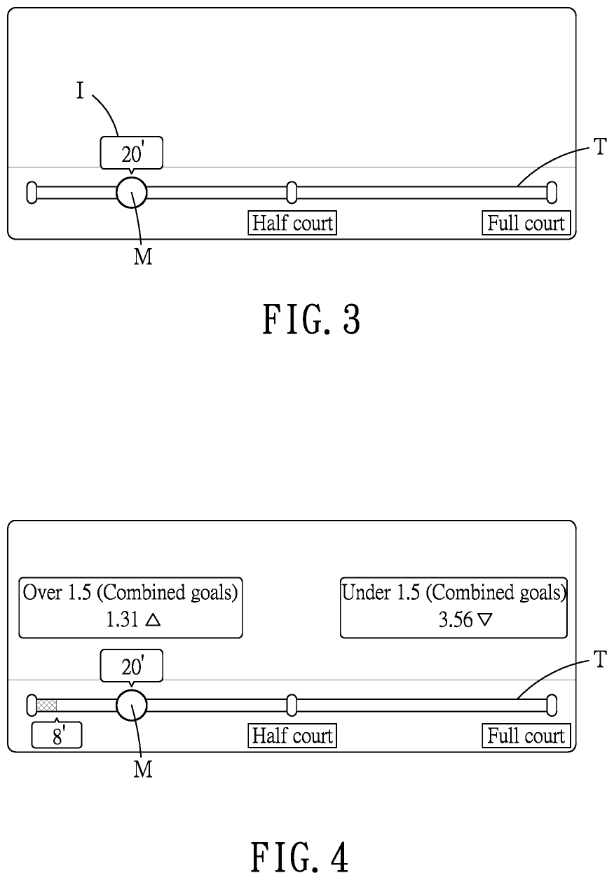

FIG. 3 illustrates an exemplary first betting page generated by the processor 13 of the server 1. In this example, the time selecting section of the first betting page includes a progress bar (T) that is used to indicate the current progress of the sports game (e.g., 8 minutes into the game, as shown in FIG. 4), and a movable object (M) superposing the progress bar (T) and allowing the user to specify a specific time instance of the sports game by moving the movable object (M) on the progress bar (T). For example, moving the movable object (M) may be implemented by an action that is known as “drag” and that can be done by the user pressing a button of the mouse to click on the movable object (M), and to move the mouse while still pressing the button. Alternatively, the user may touch the movable object (M) on the touchscreen using a finger or a stylus pen, and move the finger or the stylus pen while still touching the movable object (M).

Specifically, in the case that the sports game is a soccer game, the time selecting section of the first betting page may further include two marks on the progress bar (T) indicating a halftime and a fulltime of the soccer game.

In step S3, the user is instructed to select a specific time instance that is associated with the bet. In response, the user may operate the input interface 33 to move the movable object (18) on the progress bar (T). It is noted that as the user moves the movable object (M), a pop-up indicator (I) may be displayed to indicate a time instance associated with a location of the movable object (M) on the progress bar (I). For example, in the case of FIG. 3, the time instance associated with the location of the movable object (N) on the progress bar (T) is the 20^{th} minute of the sports game (which is for example a soccer game). As the user moves the movable object (M) to the right, a value of the time instance associated with the location of the movable object (N) is increased.

After the user selects the specific time instance associated with the bet, he/she may press a confirm button (not shown) signifying the selection of the specific time instance. As a result, the end user device transmits user-input content indicating the selection of the specific time instance to the server 1. In some embodiments, as soon as the user stops the “drag” action by letting go of the movable object (M) (e.g., releasing the button of the mouse or stopping touching the touchscreen, an action known as “drop”), the end user device 3 determines that the specific time instance is selected with the time instance associated with the location of the movable object (M) on the progress bar (T) at the time of the drop being the selected specific time instance.

In response to receipt of the user-input content, in step S4, the processor 13 of the server 1 generates a second betting page for user interaction based on the current information regarding the sports game, and transmits data of the second betting page to the end user device 3 so that the processor 30 can control the display 31 to display the second betting page. The second betting page includes a betting option section that allows the user to select a specific outcome associated with the specific time instance of the sports game. The betting option section includes a plurality of betting options each being associated with a specific outcome of the sports game at the selected specific time instance and including associated odds. The user is then allowed to place a bet by operating the second betting page displayed by the end user device 3. It should be noted that the term. “outcome” is not necessarily associated with an end result of the sports game throughout the disclosure.

It is noted that in some embodiments, the processor 13 of the server 1 determines whether the selection of the specific time instance is valid prior to generating the second betting page according to the current information of the sports game currently obtained by the server 1. It is only when the processor 13 of the server 1 determines that the selection of the specific time instance is valid will the flow proceed to S4.

For example, when a soccer game has been in progress for 8 minutes and the user has interacted with the first betting page to select a valid specific time (e.g., the 20^{th} minute), the second betting page may be generated to have a left part of the progress bar (T) displayed in another color to reflect the current progress of the soccer game, as shown in FIG. 4. When a specific time instance prior to the 8 minute is selected as a result of the user interaction with the first betting page, the processor 13 of the server 1 may determine that the selection of the specific time instance is invalid, and the flow may go back to step S3 to instruct the user to select another specific time instance. In other embodiments, the first betting page may be configured such that the movable object (M) cannot be moved to the left part of the progress bar (T) as the associated part of the sports game has been played.

After determining that the selection of the specific time instance is valid, the processor 13 of the server 1 further calculates, for the specific outcome associated with each of the two betting options, the associated odds based on the specific time instance.

FIG. 4 illustrates an example of the second betting page according to one embodiment of the disclosure. In this embodiment, the betting option section of the second betting page includes two betting options, and each of the betting options is associated with a specific outcome of the soccer game associated with the selected specific time instance (e.g., a total number of goals scored by the two parties at the 20^{th} minute), and includes associated odds. The two outcomes are that a number of goals is over 1.5 at the 20^{th} minute (i.e., Over outcome) and that a number of goals is under 1.5 at the 20^{th} minute (i.e., Under outcome), and the user is allowed to bet on at least one of the two outcomes. The odds for the over and under outcomes are 1.31 and 3.56, respectively. It is noted that in some embodiments, the user is allowed to place a bet on a specific outcome of a part of the sports game during a time interval between a time instance when the bet is placed and the specific time instance (e.g., a number of goals that are scored between the 8^{th} minute and the 20^{th} minute). In some embodiments, the user is allowed to place a bet on a specific outcome of a part of the sports game during a user-defined time interval defined by two different specific time instances that are after the time instance when the bet is placed, and that are selected by the user. For example, for a user placing a bet at the 8^{th} minute of the sports game, he/she may define a time interval between the 20^{th} minute and the 30^{th} minute. In use, the two different specific time instances constituting the time interval may be defined by user-operation to move the movable object (M) twice, each specifying one unique time instance (e.g., the 20^{th} minute and the 30^{th} minute, respectively).

The second betting page enables selection of a specific outcome associated with the specific time instance of the sports game. That is, the user is enabled to bet on at least one of the two outcomes: two or more goals are scored up to the 20^{th} minute (i.e., Over), or at most one goal is scored up to the 20^{th} minute (i.e., Under). It is noted that in some embodiments, when a bet is placed at a time instance during the sports game, the determination of the specific outcome is done with respect to a time interval between the time instance when the bet is placed and the specific time instance (i.e., between the 8^{th} minute and the 20^{th} minute).

It is noted that the odds for each of the specific outcomes may be calculated by the server 1 based on various aspects of the sports game (e.g., the selected specific time instance, results of previous matchups of the parties participating in the sports game, the home/away environments, etc.). That is to say, a party hosting the server 1 serves as a bookmaker in the sports betting to accept bets from the user and determine the odds. It is noted that, in one sports game, the outcomes and odds may be changed as the sports game progresses.

After the user selects at least one of the betting options, the second betting page may present an amount field that allows the user to input an amount of wager associated with each of the at least one of the betting options (i.e., an amount the user intends to wager in an attempt to bet on the occurrence of the specific outcome of the at least one of the betting options). It is noted that the user may be allowed to select both of the betting options, each with an associated amount of wager.

Afterward, a bet on the selection of the specific outcome associated with the specific time instance of the sports game is completed (the bet is now placed) and transmitted to the server 1.

In response to the receipt of the bet, in step S5, the server 1 enters the bet, and determines a result of the bet by comparing a result of the sports game at the specific time instance and content of the bet.

In this embodiment, the determination may be done immediately after the specific time instance. Specifically, for the example of FIG. 4, the processor 13 of the server 1 determines whether the content of the bet conforms with the result of the sports game right after the 20^{th} minute of the soccer game.

When the bet indicates that the user bets on that the number of goals scored is over 1.5, and there is actually more than two goals scored by the two parties at the selected specific time instance, the procedure goes to step S6, where the processor 13 of the server 1 determines that the bet has been won by the user. Otherwise, the procedure goes to step S7, where the processor 13 of the server 1 determines that the bet has been won by the bookmaker (i.e., the party hosting the server 1). In some embodiments, the determination may be done after the entirety of the sports game has been played.

In the case that the bet is won by the user, the processor 13 of the server 1 may proceed to authorize a payout to the user. The payout is determined by multiplying the amount of wager by the associated odds. In various embodiments, the user may use a printed ticket indicting that the bet has been accepted by the bookmaker to collect the payout at a betting station, or the payout may be transferred to an account belonging to the user.

On the other hand, in the case that the bet is won by the bookmaker, the amount of wager is collected by the bookmaker.

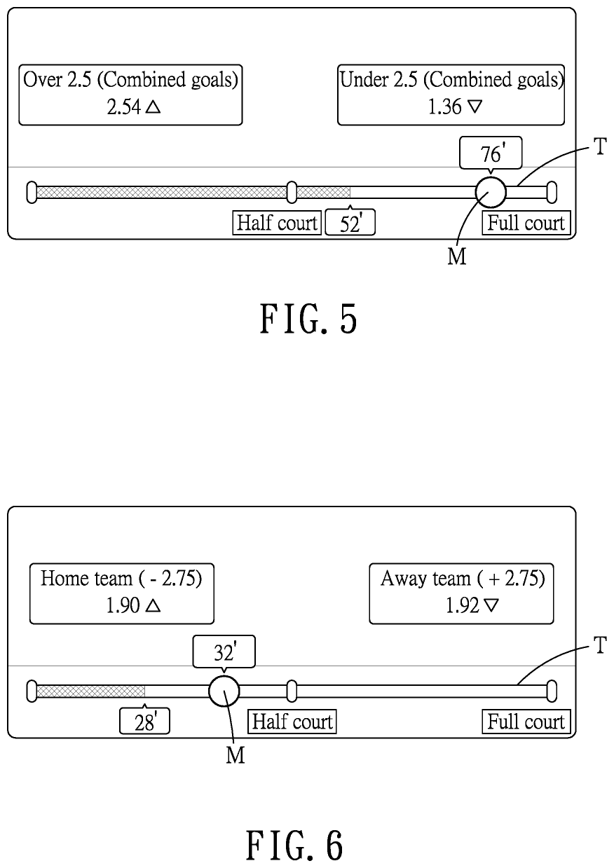

FIG. 5 illustrates another example of the second betting page according to one embodiment of the disclosure. In the example of FIG. 5, the sports game is a soccer game which has progressed to the 52^{nd} minute.

In this example, the method as shown in FIG. 1 is implemented, and the user is allowed to bet on various aspects of the soccer game at a specific time instance after the 52^{nd} minute, using the first betting page to set the specific time instance (e.g., the 76^{th} minute indicated by the movable object (M) shown in FIG. 5).

In this case, the user is allowed to bet on one of two outcomes using the second betting page displayed on the display 31 of the end user device 3. The two outcomes in the example of FIG. 5 include that a number of goals is over 2.5 at the 76^{th} minute (i.e., Over outcome) and that a number of goals is under 2.5 at the 76^{th} minute (i.e., Under outcome). The odds for the over and under outcomes are 2.54 and 1.36, respectively. It is noted that in some embodiments, the user is allowed to place a bet on a specific outcome only with respect to a time interval between the time instance when the bet is placed and the specific time instance (i.e., between the 52^{nd} minute and the 76^{th} minute in the given example). In such case, any goal scored prior to the 52^{nd} minute is irrelevant to the bet.

The user may then select at least one of the two outcomes, and input an amount of wager. The bet is then transmitted to the server 1.

In response to the receipt of the bet, in step S5, the server 1 enters the bet, and determines a result of the bet by comparing a result of the sports game at the specific time instance and content of the bet.

For the example of FIG. 5, the processor 13 of the server 1 determines whether the content of the bet conforms with the result of the sports game at the end of the 76^{th} minute.

When the bet indicates that the user bets on that the number of goals scored is under 2.5, and there is actually less than two goals scored up to the selected specific time instance, the processor 13 of the server 1 determines that the bet has been won by the user (step 6). Otherwise, the processor 13 of the server 1 determines that the bet has been won by the bookmaker (step S7).

In the case that the bet is won by the user, the processor 13 of the server 1 may proceed to authorize a payout to the user. In the case that the bet is won by the bookmaker, the amount of wager is collected by the bookmaker.

FIG. 6 illustrates another example of the second betting page according to one embodiment of the disclosure. In the example of FIG. 6, the sports game is a soccer game which has progressed to the 28^{th} minute.

In this example, the user is allowed to bet on various aspects of the soccer game at a specific time instance after the 28^{th} minute, using the first betting page to set the specific time instance (e.g., the 32^{th} minute indicated by the movable object (M) shown in FIG. 6).

In this example, the user is allowed to make a handicap betting. That is to say, in a sports game that the bookmaker determines that the parties playing the sports game are not balanced (e.g., the home team typically enjoys some degree of advantage playing in its own facility), an actual score may be adjusted by a predetermined amount (known as a handicap) to create a handicapped outcome, such that the handicapped outcomes of the two parties (and therefore the odds for each party winning the handicapped outcome) may be more balanced. That is to say, the bookmaker may give a virtual advantage to a weaker one of the parties by adding the handicap to an actual score of the weaker one, and/or give a virtual disadvantage to a stronger one of the parties by subtracting the handicap from an actual score of the stronger one.

In the example of FIG. 6, the handicap is predetermined to be −2.75 goals against the home team. That is to say, in determining the handicapped outcomes, 2.75 goals will be subtracted from the actual goal numbers from the home team. In displaying such a handicap, the home team will be labeled with (−2.75) and the away team will be labeled with (+2.75).

There are two scenarios that may be played out regarding the handicapped outcomes: the home team leads by more than 2.75 goals at the 32^{nd} minute (i.e., home-winning outcome); and the home team leads by less than 2.75 goals, ties with the away team, or is trailing by any goals at the 32^{nd} minute (i.e., home-losing outcome). The odds for the home-winning and home-losing outcomes are 1.90 and 1.92, respectively. It is noted that in some embodiments, the user is allowed to place a bet on a specific outcome only with respect to a time interval between the time instance when the bet is placed and the specific time instance (i.e., between the 28^{th} minute and the 32^{nd} minute); that is, only goals scored during this four-minute interval counts.

In response to the receipt of the bet, in step S5, the server 1 enters the bet, and determines a result of the bet by comparing a result of the sports game at the specific time instance and content of the bet.

In this embodiment, the determination may be done immediately after the specific time instance. Specifically, for the example of FIG. 6, the processor 13 of the server 1 determines whether the content of the bet conforms with the result of the sports game at the end of the 32^{nd} minute.

When the bet indicates that the user bets on the home team to win the handicapped outcome (home-winning), and the home team leads by more than 2.75 goals at the 32^{nd} minute, the processor 13 of the server 1 determines that the bet has been won by the user (step S6). Otherwise, the processor 13 of the server 1 determines that the bet has been won by the bookmaker (step S7).

In the case that the bet is won by the user, the processor 13 of the server 1 may proceed to authorize a payout to the user. On the other hand, in the case that the bet is won by the bookmaker, the amount of wager is collected by the bookmaker.

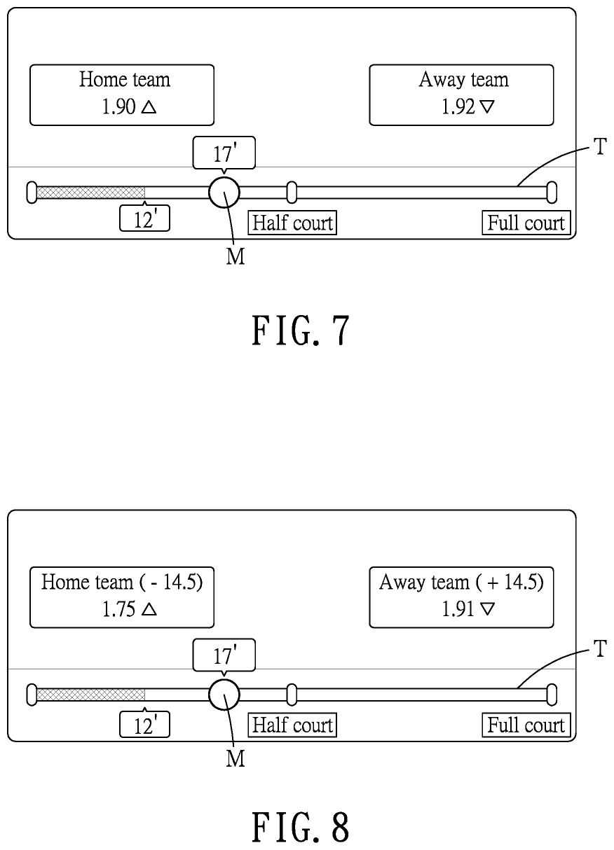

FIG. 7 illustrates another example of the second betting page according to one embodiment of the disclosure. In this embodiment, the sports game is a basketball game which includes two 20-minute periods, and which has progressed to the 12^{th} minute.

The second betting page includes two betting options, and each of the betting options is associated with a specific outcome of the basketball game (i.e., the team leading in score) associated with the selected specific time instance (i.e., a score at the 17^{th} minute), and includes associated odds.

There are two scenarios that may be played out regarding the specific outcomes: the home team is leading by any point at the 17^{th} minute (i.e., Home); and the home team is trailing by any point at the 17^{th} minute (i.e., Away). The odds for the home and away outcomes are 1.90 and 1.92, respectively. It is noted that in some embodiments, the user is allowed to place a bet on a specific outcome only with respect to a time interval between the time instance when the bet is placed and the specific time instance (i.e., between the 12^{th} minute and the 17^{th} minute).

In response to the receipt of the bet, in step S5, the server 1 enters the bet, and determines a result of the bet by comparing a result of the sports game at the specific time instance and content of the bet.

In this embodiment, the determination of the result of the bet may be done immediately after the specific time instance. Specifically, for the example of FIG. 7, the processor 13 of the server 1 determines whether the content of the bet conforms with the result of the sports game at the end of the 17^{th} minute.

When the bet indicates that the user bets on the home team to win (Home), and the home team is leading by any point at the 17^{th} minute, the processor 13 of the server 1 determines that the bet has been won by the user (step S6). Otherwise, the processor 13 of the server 1 determines that the bet has been won by the bookmaker (step S7).

In the case that the bet is won by the user, the processor 13 of the server 1 may proceed to authorize a payout to the user. On the other hand, in the case that the bet is won by the bookmaker, the amount of wager is collected by the bookmaker.

FIG. 8 illustrates another example of the second betting page according to one embodiment of the disclosure. In this embodiment, the sports game is a basketball game which has progressed to the 12^{th} minute.

The second betting page includes two betting options, and each of the betting options is associated with a specific outcome of the basketball game (i.e., a handicapped outcome, where the handicap is 14.5 points against the home team) associated with the selected specific time instance (i.e., a score at the 17^{th} minute), and includes associated odds.

There are two scenarios that may be played out regarding the handicapped outcomes: the home team is leading by more than 14.5 points at the 17^{th} minute (i.e., Home); and the home team is leading by less than 14.5 points, ties with the away team, or is trailing by any point at the 17^{th} minute (i.e., Away). The odds for the home and away outcomes are 1.75 and 1.91, respectively.

In response to the receipt of the bet, in step S5, the server 1 enters the bet, and determines a result of the bet by comparing a result of the sports game at the specific time instance and content of the bet.

In this embodiment, the determination of the result of the bet may be done immediately after the specific time instance. Specifically, for the example of FIG. 8, the processor 13 of the server 1 determines whether the content of the bet conforms with the result of the sports game at the end of the 17^{th} minute.

When the bet indicates that the user bets on the home team to win the handicapped outcome, and the home team leads by more than 14.5 points at the 17^{th} minute, the processor 13 of the server 1 determines that the bet has been won by the user (step S6). Otherwise, the processor 13 of the server 1 determines that the bet has been won by the bookmaker (step S7).

In the case that the bet is won by the user, the processor 13 of the server 1 may proceed to authorize a payout to the user. On the other hand, in the case that the bet is won by the bookmaker, the amount of wager is collected by the bookmaker.

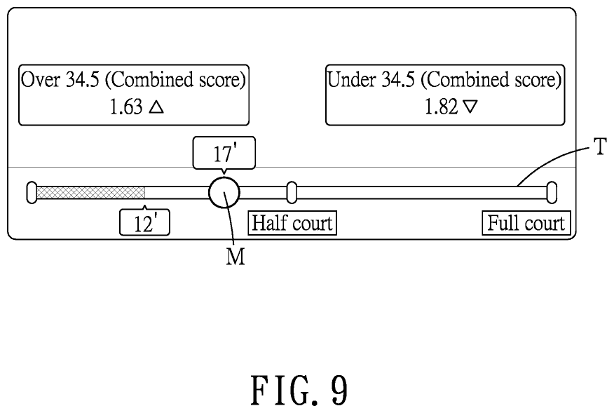

FIG. 9 illustrates another example of the second betting page according to one embodiment of the disclosure. In this embodiment, the sports game is a basketball game which has progressed to the 12^{th} minute.

The second betting page includes two betting options, and each of the betting options is associated with a specific outcome of the basketball game (i.e., whether a combined score by adding the points scored by both teams is more or less than a predetermined over/under value, also known as an O/U) associated with the selected specific time instance (i.e., the combined score at the 17^{th} minute), and includes associated odds.

There are two scenarios that may be played out: the combined score is more than the O/U at the 17^{th} minute (i.e., Over); and the combined score is less than the O/U at the 17^{th} minute (i.e., Under). In this example, the O/U is 34.5, and the odds for the over and under outcomes are 1.63 and 1.82, respectively. It is noted that in some embodiments, the user is allowed to place a bet on a specific outcome only with respect to a time interval between the time instance when the bet is placed and the specific time instance (i.e., between the 12^{th} minute and the 17^{th} minute). For example, the user is allowed to place a bet on whether a combined score scored by the two teams during the time interval only is more or less than an O/U.

In response to the receipt of the bet, in step S5, the server 1 enters the bet, and determines a result of the bet by comparing a result of the sports game at the specific time instance and content of the bet.

In this embodiment, the determination of the result of the bet may be done immediately after the specific time instance. Specifically, for the example of FIG. 9, the processor 13 of the server 1 determines whether the content of the bet conforms with the result of the sports game at the end of the 17^{th} minute.

When the bet indicates that the user bets on the combined score to be more than the O/U (Over), and the combined score is actually more than the O/U at the 17^{th} minute, the processor 13 of the server 1 determines that the bet has been won by the user (step S6). Otherwise, the processor 13 of the server 1 determines that the bet has been won by the bookmaker (step S7).

In the case that the bet is won by the user, the processor 13 of the server 1 may proceed to authorize a payout to the user. On the other hand, in the case that the bet is won by the bookmaker, the amount of wager is collected by the bookmaker.

It is noted that in some examples, additional betting options may be presented in the betting option section of the second betting page for allowing the user to place a bet. For example, in the case of a soccer game, a third betting option of a draw may be added.

To sum up, the embodiments of the disclosure provide a method for processing a bet on a sports game. In the method, a user is allowed to select a specific time instance within the sports game, and to make a bet on an outcome of the sports game at the specific time instance.

According to one embodiment, the system may include the server 1 that is configured to communicate with the end user device 3 owned by the user (e.g., a smartphone). In such a case, the user is able to operate his/her own end user device to communicate with the server 1 and to place the bet.

According to one embodiment of the disclosure, there is provided a non-transitory storage medium which stores computer readable instructions that, when executed by a processor of a computing device, cause the processor to perform the steps of the method as shown in FIG. 1.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for processing a bet on a sports game, the method being implemented using a server communicating with an end user device and comprising steps of:
generating a first betting page for user interaction and transmitting data of the first betting page to the end user device for the end user device to display the first betting page, the first betting page including a time selecting section that allows selection of a specific time instance associated with a sports game;
in response to receipt of user-input content indicating the selection of the specific time instance, generating a second betting page for user interaction and transmitting data of the second betting page to the end user device for the end user device to display the second betting page, the second betting page including a betting option section that allows selection of a specific outcome associated with the specific time instance of the sports game; and
in response to receipt of a bet that indicates the selection of the outcome associated with the specific time instance of the sports game, determining a result of the bet by comparing a result of the sports game at the specific time instance and content of the bet.

2. The method of claim 1, wherein:
the betting option section of the second betting page includes at least two betting options, and each of the two betting options is associated with a specific outcome of the sports game and includes associated odds; and
the bet includes selection of at least one of the two betting options and an amount of wager associated with each of the at least one of the two betting options.

3. The method of claim 2, further comprising, prior to the step of generating the second betting page:
determining whether the selection of the specific time instance is valid; and
after determining that the selection of the specific time instance is valid, calculating, for each of the two betting options, the associated odds based on the specific time instance.

4. The method of claim 1, wherein:
the time selecting section of the first betting page includes a progress bar that indicates a current progress of the sports game, and a movable object that superposes the progress bar and that allows a user to specify the specific time instance by moving the movable object on the progress bar.

5. A system for processing a bet on a sports game, comprising:
a server; and
an end user device that is in communication with said server and that includes an input interface and a display,
wherein said server is configured to generate a first betting page and to transmit data of the first betting page to said end user device so that said display is controlled to display the first betting page, the first betting page including a time selecting section that allows selection of a specific time instance associated with a sports game;
wherein, in response to receipt of user-input content indicating the selection of the specific time instance, said end user device transmits the user-input content to said server, and said server is configured to generate a second betting page and to transmit data of the second betting page to said end user device so that said display is controlled to display the second betting page for user interaction, the second betting page including a betting option section that allows selection of a specific outcome associated with the specific time instance of the sports game; and
wherein, in response to receipt of a bet that indicates the selection of the outcome associated with the specific time instance of the sports game, said end user device transmits the bet to said server, and said server is configured to determine a result of the bet by comparing a result of the sports game at the specific time instance and content of the bet.

6. The system of claim 5, wherein:
the betting option section of the second betting page generated by said server includes at least two betting options, and each of the two betting options is associated with a specific outcome of the sports game and includes associated odds; and
the bet received by said end user device includes selection of at least one of the two betting options and an amount of wager associated with each of the at least one of the two betting options.

7. The system of claim 5, wherein, prior to generating the second betting page, said server is further configured to:
determine whether the selection of the specific time instance is valid; and
after determining that the selection of the specific time instance is valid, calculate, for each of the two betting options, the associated odds based on the specific time instance.

8. The system of claim 5, wherein the time selecting section of the first betting page generated by said server includes a progress bar that indicates a current progress of the sports game, and a movable object that superposes the progress bar and that allows a user to specify the specific time instance by moving the movable object on the progress bar.

9. A server for processing a bet on a sports game, comprising:
a data storage storing current information regarding a sports game and instructions;
a communication unit configured to communicate with an end user device; and
a processor configured to execute the instructions stored in said data storage to
generate a first betting page, and transmit data of the first betting page to the end user device for the end user device to display the first betting page for user interaction, the first betting page including a time selecting section that allows selection of a specific time instance associated with the sports game,
in response to receipt of user-input content indicating the selection of the specific time instance from the end user device, generate a second betting page based on the current information of the sports game, and transmit data of the second betting page to the end user device for the end user device to display the second betting page for user interaction, the second betting page including a betting option section that allows selection of a specific outcome associated with the specific time instance of the sports game, and
in response to receipt of a bet that indicates the selection of the outcome associated with the specific time instance of the sports game from the end user device, determine a result of the bet by comparing a result of the sports game at the specific time instance and content of the bet.

10. A non-transitory storage medium storing computer readable instructions that, when executed by a processor of a computing device, cause the processor to perform the steps of the method of claim 1.
